(19) United States
(12) Patent Application Publication
(10) Pub. No.: US 2008/0100537 A1
(43) Pub. Date: May 1, 2008

(54) PLASMA DISPLAY APPARATUS AND METHOD OF DRIVING THE SAME

(76) Inventors: Seongnam Ryu, Gumi-city (KR); Woogon Jeon, Gumi-city (KR); Sangdae Park, Gumi-city (KR); Kyunga Kang, Gumi-city (KR); Jeonghyun Hamh, Gumi-city (KR); Jaesung Kim, Gumi-city (KR)

Correspondence Address: KED & ASSOCIATES, LLP, P.O. Box 221200, Chantilly, VA, 20153-1200, US

(21) Appl. No.: 11/925,038

(22) Filed: Oct. 26, 2007

(30) Foreign Application Priority Data
Oct. 27, 2006 (KR) 10-2006-0105350

(51) Int. Cl. G09G 3/28

(52) U.S. Cl. 345/60

(57) ABSTRACT

A plasma display apparatus and a method of driving the same are disclosed. The plasma display apparatus includes a plasma display panel including a first electrode, a second electrode and a third electrode intersecting the first electrode and the second electrode and a driver. At least one of the first electrode and the second electrode has a single-layered structure. The driver supplies sustain signals to the first electrode and the second electrode during a sustain period of a frame. The sustain signal supplied to the first electrode overlaps the sustain signal supplied to the second electrode.

This application claims the benefit of Korean Patent Application No. 10-2006-0105350 filed on Oct. 27, 2006, which is hereby incorporated by reference.

### BACKGROUND OF THE DISCLOSURE

1. Field of the Disclosure

This document relates to a plasma display apparatus and a method of driving the same.

2. Description of the Background Art

A plasma display apparatus includes a plasma display panel including a plurality of electrodes and a driver supplying driving signals to the electrodes of the plasma display panel.

The plasma display panel includes phosphor layers inside discharge cells partitioned by barrier ribs. The driver supplies the driving signals to the discharge cells through the electrodes.

When the driving signal generates a discharge inside the discharge cells, a discharge gas filled in the discharge cells generates vacuum ultraviolet rays, which thereby cause phosphors formed inside the discharge cells to emit light, thus displaying an image on the screen of the plasma display panel.

### SUMMARY OF THE DISCLOSURE

This document provides a plasma display apparatus and a method of driving the same capable of reducing the manufacturing cost and improving the driving efficiency.

In one aspect, a plasma display apparatus comprises a plasma display panel including a first electrode, a second electrode and a third electrode intersecting the first electrode and the second electrode, at least one of the first electrode and the second electrode having a singe-layered structure, and a driver that supplies sustain signals to the first electrode and the second electrode during a sustain period of a frame, wherein the sustain signal supplied to the first electrode overlaps the sustain signal supplied to the second electrode.

In another aspect, a method of driving a plasma display apparatus including a plasma display panel including a first electrode, a second electrode and a third electrode intersecting the first electrode and the second electrode, at least one of the first electrode and the second electrode having a singe-layered structure, the method comprises supplying first and second sustain signals to the first electrode and the second electrode, respectively, so that the first sustain signal supplied to the first electrode overlaps the second sustain signal supplied to the second electrode.

In still another aspect, a method of driving a plasma display apparatus including a plasma display panel including a first electrode, a second electrode and a third electrode intersecting the first electrode and the second electrode, at least one of the first electrode and the second electrode having a singe-layered structure, the method comprises successively supplying first and second sustain signals to the first and second electrodes, respectively, successively supplying third and fourth sustain signals to the first and second electrodes, respectively, wherein the first sustain signal overlaps the second sustain signal during a first period, and the third sustain signal overlaps the fourth sustain signal during a second period whose a time width is different from a time width of the first period.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 illustrates an example of a configuration of a plasma display apparatus according to an exemplary embodiment;

FIGS. 2 to 5 illustrate an example of a structure of a plasma display panel of the plasma display apparatus according to the exemplary embodiment;

FIG. 6 illustrates a reason why at least one of a first electrode and a second electrode has a single-layered structure;

FIG. 7 illustrates an example of a structure in which a black layer is added between first and second electrodes and a front substrate;

FIGS. 8 to 11 illustrate a first implementation associated with first and second electrodes of a plasma display panel applicable to the plasma display apparatus according to the exemplary embodiment;

FIGS. 12 and 13 illustrate a second implementation associated with first and second electrodes of a plasma display panel applicable to the plasma display apparatus according to the exemplary embodiment;

FIGS. 14 and 15 illustrate a third implementation associated with first and second electrodes of a plasma display panel applicable to the plasma display apparatus according to the exemplary embodiment;

FIGS. 16 and 17 illustrate a fourth implementation associated with first and second electrodes of a plasma display panel applicable to the plasma display apparatus according to the exemplary embodiment;

FIGS. 18 and 19 illustrate a fifth implementation associated with first and second electrodes of a plasma display panel applicable to the plasma display apparatus according to the exemplary embodiment;

FIG. 20 illustrates a sixth implementation associated with first and second electrodes of a plasma display panel applicable to the plasma display apparatus according to the exemplary embodiment;

FIG. 21 illustrates a frame for achieving a gray scale of an image in the plasma display apparatus according to the exemplary embodiment;

FIG. 22 illustrates an example of an operation of the plasma display apparatus according to the exemplary embodiment;

FIGS. 23 and 24 illustrate another form of a rising signal or a second falling signal;

FIG. 25 illustrates a first implementation of a sustain signal;

FIG. 26 illustrates a second implementation of a sustain signal;

FIG. 27 illustrates a third implementation of a sustain signal;

FIG. 28 illustrates a fourth implementation of a sustain signal;

FIG. 29 illustrates a fifth implementation of a sustain signal;

FIG. 30 illustrates a sixth implementation of a sustain signal; and

FIG. 31 illustrates a seventh implementation of a sustain signal.

### DETAILED DESCRIPTION OF EMBODIMENTS

Reference will now be made in detail embodiments of the invention examples of which are illustrated in the accompanying drawings.

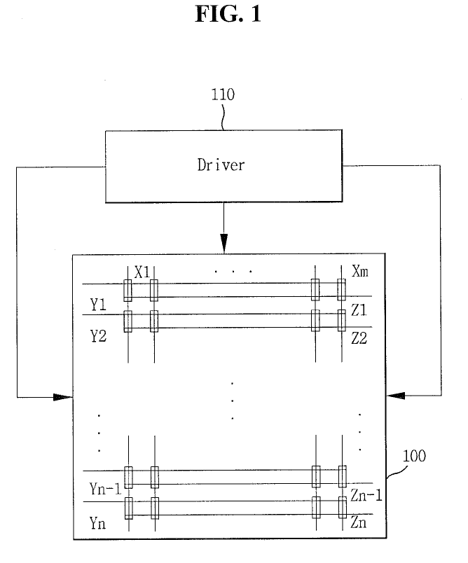

FIG. 1 illustrates an example of a configuration of a plasma display apparatus according to an exemplary embodiment.

As illustrated in FIG. 1, the plasma display apparatus according to the embodiment includes a plasma display panel 100 and a driver 110.

The plasma display panel 100 includes first electrodes Y1 to Yn and second electrodes Z1 to Zn positioned parallel to each other and third electrodes X1 to Xm intersecting the first electrodes Y1 to Yn and the second electrodes Z1 to Zn.

The driver 110 supplies sustain signals to the first electrodes Y1 to Yn and the second electrodes Z1 to Zn during a sustain period of a frame. The sustain signal supplied to the first electrodes Y1 to Yn overlaps the sustain signal supplied to the second electrodes Z1 to Zn.

In FIG. 1, the driver 110 is formed in the form of a signal board. However, the driver 110 may be formed in the form of a plurality of boards depending on the electrodes of the plasma display panel 100.

For instance, the driver 110 may include a first driver (not shown) for driving the first electrodes Y1 to Yn, a second driver for driving the second electrodes Z1 to Zn and a third driver (not shown) for driving the third electrodes X1 to Xm.

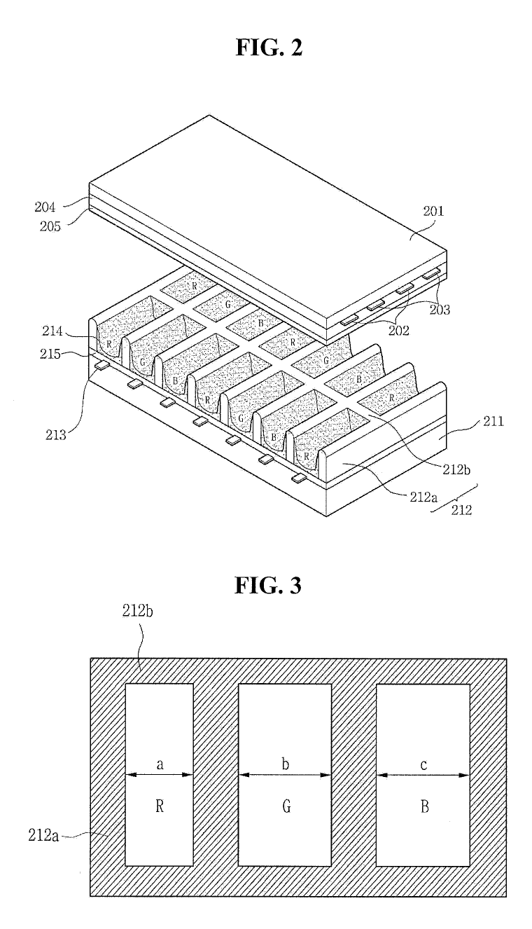

FIGS. 2 to 5 illustrate an example of a structure of a plasma display panel of the plasma display apparatus according to the exemplary embodiment.

As illustrated in FIG. 2, the plasma display panel of the plasma display apparatus according to the exemplary embodiment includes a front substrate 201 and a rear substrate 211 which coalesce each other. On the front substrate 201, a first electrode 202 and a second electrode 203 are positioned in parallel to each other. On the rear substrate 211, a third electrode 213 is positioned to intersect the first electrode 202 and the second electrode 203.

At least one of the first electrode 202 and the second electrode 203 has a single-layered structure. For instance, at least one of the first electrode 202 and the second electrode 203 may be an electrode with an ITO (indium-tin-oxide)-less structure not including a transparent electrode.

At least one of the first electrode 202 and the second electrode 203 may include an electrically conductive metal material. Examples of the electrically conductive metal material include silver (Ag), copper (Cu), aluminum (Al), and the like. Because at least one of the first electrode 202 and the second electrode 203 includes the electrically conductive metal material, a color of at least one of the first electrode 202 and the second electrode 203 may be darker than a color of an upper dielectric layer 204.

The first electrode 202 and the second electrode 203 receive driving signals for generating a discharge inside discharge cells and maintaining the discharge.

The upper dielectric layer 204 for covering the first electrode 202 and the second electrode 203 is positioned on the front substrate 201 on which the first electrode 202 and the second electrode 203 are positioned. The upper dielectric layer 204 limits discharge currents of the first electrode 202 and the second electrode 203 and provides insulation between the first electrode 202 and the second electrode 203.

A protective layer 205 is positioned on the front substrate 201, on which the upper dielectric layer 204 is positioned, by depositing a material such as magnesium oxide (MgO) on the upper dielectric layer 204.

A lower dielectric layer 215 for covering the third electrode 213 is positioned on the rear substrate 211 on which the third electrode 213 is positioned. The lower dielectric layer 215 provides insulation of the third electrode 213.

Barrier ribs 212 are positioned on the lower dielectric layer 215 to partition discharge spaces (i.e., discharge cells). A red (R) discharge cell, a green (G) discharge cell and a blue (B) discharge cell, and the like, are positioned between the barrier ribs 212. The red (R), green (G) and blue (B) discharge cells may be classified depending on a color of light coming from each discharge cell.

In addition to the red (R), green (G) and blue (B) discharge cells, a white discharge cell or a yellow discharge cell may be further positioned between the barrier ribs 212.

Widths of the red (R), green (G) and blue (B) discharge cells may be substantially equal to one another. Further, a width of at least one of the red (R), green (G) or blue (B) discharge cells may be different from widths of the other discharge cells.

For instance, as illustrated in FIG. 3, a width (a) of the red (R) discharge cell is the smallest, and widths (b and c) of the green (G) and blue (B) discharge cells are larger than the width (a) of the red (R) discharge cell. The width (b) of the green (G) discharge cell may be substantially equal to or different from the width (c) of the blue (B) discharge cell.

The widths of the R, G and B discharge cells determine a width of a phosphor layer 214 positioned inside the R, G and B discharge cells. For instance, in a case of FIG. 3, a width of a blue (B) phosphor layer positioned inside the blue (B) discharge cell is larger than a width of a red (R) phosphor layer positioned inside the red (R) discharge cell. Further, a width of a green (G) phosphor layer positioned inside the green (G) discharge cell is larger than the width of the red (R) phosphor layer. Hence, a color temperature of an image displayed on the plasma display panel can be improved.

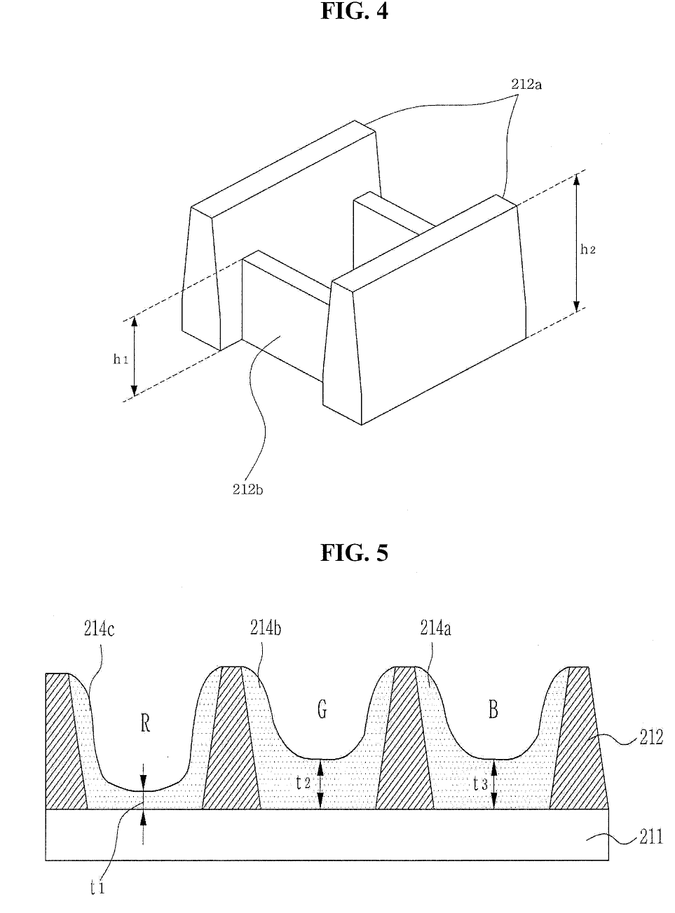

The plasma display panel may have various forms of barrier rib structures as well as a structure of the barrier rib 212 illustrated in FIG. 2. For instance, the barrier rib 212 may include a first barrier rib 212b and a second barrier rib 212a. The barrier rib 212 may have a differential type barrier rib structure in which a height of the first barrier rib 212b and a height of the second barrier rib 212a are different from each other, a channel type barrier rib structure in which a channel usable as an exhaust path is formed on at least one of the first barrier rib 212b or the second barrier rib 212a, a hollow type barrier rib structure in which a hollow is formed on at least one of the first barrier rib 212b or the second barrier rib 212a, and the like. In the differential type barrier rib structure, as illustrated in FIG. 4, a height h1 of the first barrier rib 212b is smaller than a height h2 of the second barrier rib 212a.

While the plasma display panel has been illustrated and described to have the red (R), green (G) and blue (B) discharge cells arranged on the same line, it is possible to arrange them in a different pattern. For instance, a delta type arrangement in which the red (R), green (G) and blue (B) discharge cells are arranged in a triangle shape may be applicable. Further, the discharge cells may have a variety of polygonal shapes such as pentagonal and hexagonal shapes as well as a rectangular shape.

The phosphor layer 214 emitting visible light during the generation of a sustain discharge is positioned inside the discharge cell partitioned by the barriers 212.

A thickness of at least one of the phosphor layers 214 inside the red (R), green (G) and blue (B) discharge cells may be different from thicknesses of the other phosphor layers. For instance, as illustrated in FIG. 5, thicknesses t2 and t3 of phosphor layers 214b and 214a inside the green (G) and blue (B) discharge cells are larger than a thickness t1 of a phosphor layer 214c inside the red (R) discharge cell. The thickness t2 of the phosphor layer 214b inside the green (G) discharge cell may be substantially equal to or different from the thickness t3 of the phosphor layer 214a inside the blue (B) discharge cell.

It should be noted that only one example of the plasma display panel applicable to the plasma display apparatus according to the exemplary embodiment has been illustrated and described above, and the exemplary embodiment is not limited to the plasma display panel of the above-described structure. A black layer (not shown) for absorbing external light may be further positioned on the barrier rib 212 to prevent the reflection of the external light caused by the barrier rib 212.

Further, another black layer (not shown) may be further positioned at a specific position of the front substrate 201 corresponding to the barrier rib 212.

The third electrode 213 positioned on the rear substrate 211 may have a substantially constant width or thickness. Further, a width or thickness of the third electrode 213 inside the discharge cell may be different from a width or thickness of the third electrode 213 outside the discharge cell. For instance, a width or thickness of the third electrode 213 inside the discharge cell may be larger than a width or thickness of the third electrode 213 outside the discharge cell.

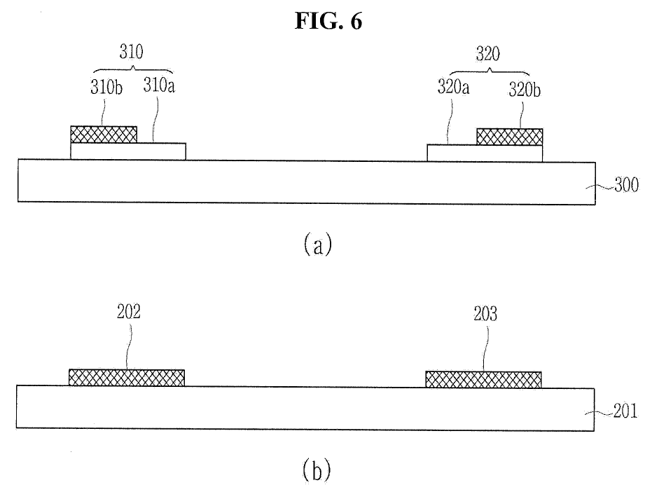

As illustrated in (a) of FIG. 6, unlike the exemplary embodiment, a first electrode 310 and a second electrode 320 each have a multi-layered structure on a front substrate 300. For instance, the first electrode 310 and the second electrode 320 each include transparent electrodes 310a and 320a and bus electrodes 310b and 320b.

The transparent electrodes 310a and 320a may include an expensive material such as ITO. The expensive material may cause an increase in the manufacturing cost.

On the contrary, as illustrated in (b) of FIG. 6, the first electrode 202 and the second electrode 203 according to the exemplary embodiment each have a single-layered structure. Hence, a manufacturing process can be simple, and the manufacturing cost can reduced because an expensive material such as ITO is not used.

As illustrated in FIG. 7, black layers 400a and 400b may be positioned between the front substrate 201 and at least one of the first electrode 202 or the second electrode 203, thereby preventing discoloration of the front substrate 201. A color of the black layers 400a and 400b is darker than a color of at least one of the first electrode 202 or the second electrode 203.

As above, when the black layers 400a and 400b are positioned between the front substrate 201 and the second electrode 203 and between the front substrate 201 and the first electrode 202, respectively, the generation of reflection light can be prevented even if the first and second electrodes 202 and 203 are formed of a material with a high reflectivity.

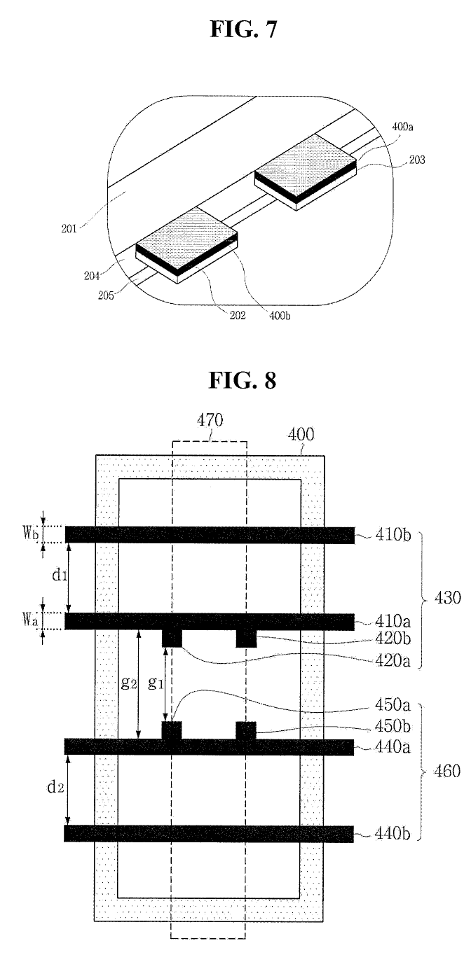

As illustrated in FIG. 8, at least one of a first electrode 430 or a second electrode 460 may include at least one line portion. The first electrode 430 includes two line portions 410a and 410b, and the second electrode 460 includes two line portions 440a and 440b.

The line portions 410a, 410b, 440a and 440b each intersect a third electrode 470 inside a discharge cell partitioned by a barrier rib 400.

The line portions 410a, 410b, 440a and 440b are spaced apart from one another with a predetermined distance therebetween. For instance, the first and second line portions 410a and 410b of the first electrode 430 are spaced apart from each other with a distance d1 therebetween. The first and second line portions 1440a and 1440b of the second electrode 1460 are spaced apart from each other with a distance d2 therebetween. The distance d1 may be equal to or different from the distance d2.

The line portions 410a, 410b, 440a and 440b may have a predetermined width. For instance, the first line portion 410a of the first electrode 430 has a width of Wa, and the second line portion 410b of the first electrode 430 has a width of Wb. A shape of the first electrode 430 may be symmetrical or asymmetrical to a shape of the second electrode 460 inside the discharge cell. For instance, while the first electrode 430 may include three line portions, the second electrode 460 may include two line portions.

At least one of the first electrode 430 or the second electrode 460 may include at least one projecting portion. For instance, the first electrode 430 includes two projecting portions 420a and 420b, and the second electrode 460 includes two projecting portions 450a and 450b. The projecting portions 420a and 420b of the first electrode 430 project from the first line portion 410a, and the projecting portions 450a and 450b of the second electrode 460 project from the first line portion 440a. The projecting portions 420a, 420b, 450a and 450b are parallel to the third electrode 470.

An interval g1 between the first and second electrodes 430 and 460 at the projecting portions 420a, 420b, 450a and 450b is shorter than an interval g2 between the first and second electrodes 430 and 460 in the discharge cell. Accordingly, a firing voltage of a discharge generated between the first electrode 430 and the second electrode 460 can be lowered.

At least one of the projecting portions 420a, 420b, 450a and 450b may overlap the third electrode 470 inside the discharge cell. Therefore, a firing voltage between the first electrode 430 and the third electrode 470 and a firing voltage between the second electrode 460 and the third electrode 470 can be lowered. Further, the driving efficiency and an address jitter characteristic can be improved.

A discharge generated between the projecting portions 420a and 420b of the first electrode 430 and the projecting portions 450a and 450b of the second electrode 460 can be diffused into the first and second line portions 410a and 410b of the first electrode 430 and the first and second line portions 440a and 440b of the second electrode 460. While the first electrode 430 and the second electrode 460 each include two projecting portions in FIG. 8, each of the first electrode 430 and the second electrode 460 may include three projecting portions as illustrated in FIG. 9. As above, the number of projecting portions may be changed variously.

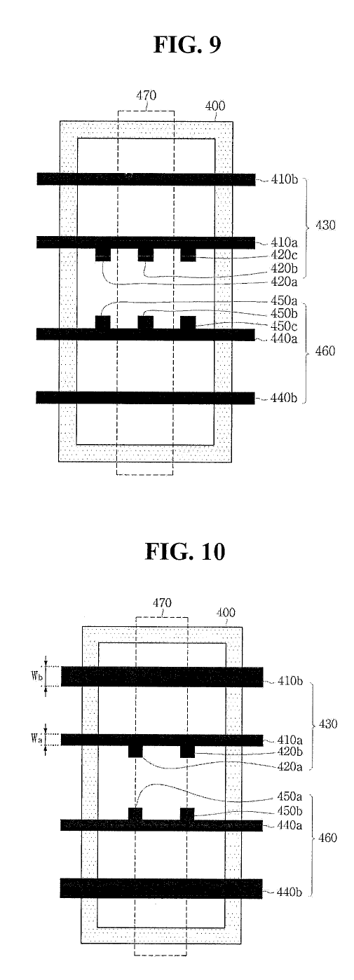

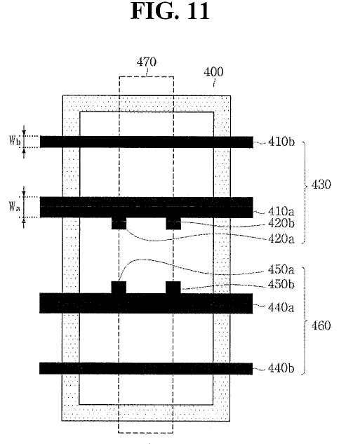

As illustrated in FIG. 10, a width of at least one of the plurality of line portions 410a, 410b, 440a and 440b may be different from widths of the other line portions. For instance, a width Wa of the first line portion 410a may be smaller than a width Wb of the second line portion 410b. As illustrated in FIG. 11, a width Wa of the first line portion 410a may be larger than a width Wb of the second line portion 410b.

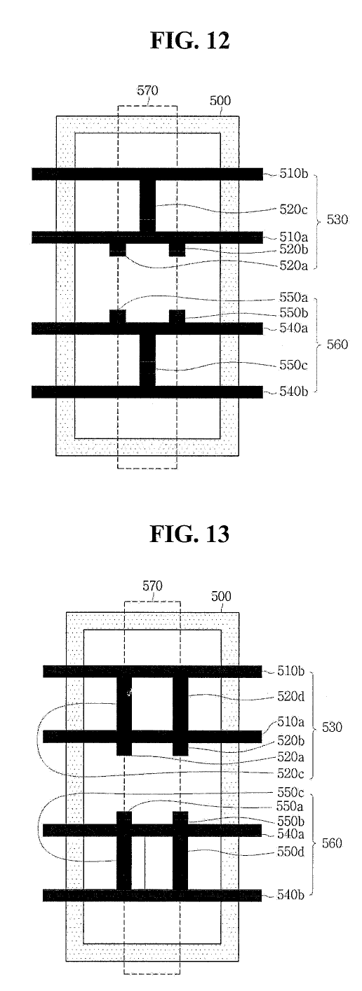

As illustrated in FIG. 12, a connecting portion 520c of a first electrode 530 connects first and second line portions 510a and 510b of the first electrode 530 to each other. A connecting portion 550c of a second electrode 560 connects first and second line portions 540a and 540b of the second electrode 560 to each other. Hence, a discharge can be easily diffused inside a discharge cell partitioned by a barrier rib 500.

Accordingly, a discharge can be easily diffused inside a discharge cell partitioned by a barrier rib 500 due to the connecting portions 520c and 550c.

As illustrated in FIG. 13, the first and second line portions 510a and 510b of the first electrode 530 may be connected using two connecting portions 520c and 520d. The connecting portion may be positioned in the same line as the projecting portion. Otherwise, the connecting portion may not be positioned in the same line as the projecting portion.

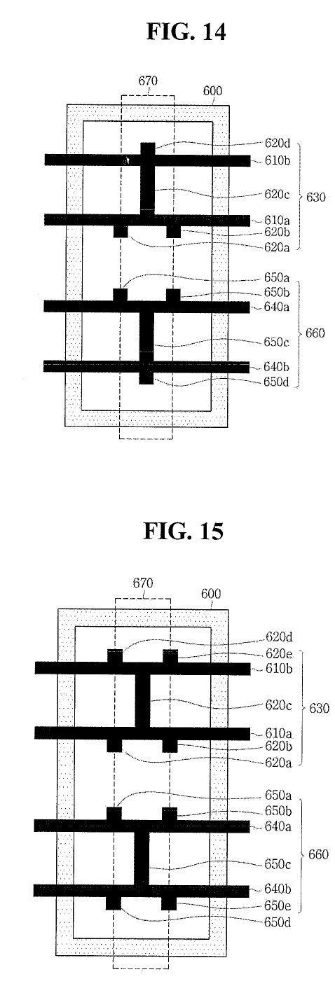

Referring to FIG. 14, at least one of a plurality of projecting portions 620a, 620b and 620d of a first electrode 630 and at least one of a plurality of projecting portions 650a, 650b and 650d of a second electrode 660 may project toward a first direction. At least one of the plurality of projecting portions 620a, 620b and 620d of the first electrode 630 and at least one of the plurality of projecting portions 650a, 650b and 650d of the second electrode 660 may project toward a second direction that is opposite to the first direction. For instance, the first direction may be a direction toward the center of a discharge cell, and the second direction may be an outward direction of the discharge cell. The projecting portions 620a, 620b, 650a and 650b projecting toward the first direction is called a first projecting portion, and the projecting portions 620d and 650d projecting toward the second direction is called a second projecting portion.

The projecting portions 620a, 620b, 620d, 650a, 650b and 650d projecting toward the first and second directions can more widely diffuse a discharge inside the discharge cell.

While the first and second electrodes 630 and 660 each include only one second projecting portion projecting toward the second direction in FIG. 14, each of the first and second electrodes 630 and 660 may include two second projecting portions 620d, 620e, 650d and 650e as illustrated in FIG. 15.

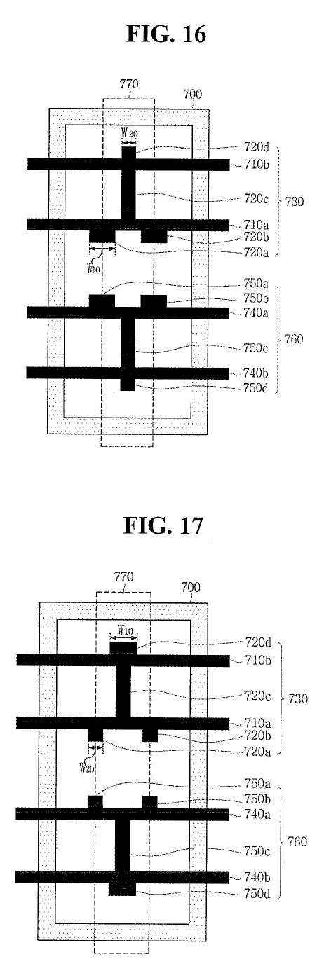

As illustrated in FIG. 16, a shape of first projecting portions 720a, 720b, 750a and 750b projecting toward a first direction may be different from a shape of second projecting portions 720d and 750d projecting toward a second direction.

For instance, a width W10 of the first projecting portions 720a, 720b, 750a and 750b may be larger than a width W20 of the second projecting portions 720d and 750d.

When the width W10 of the first projecting portions 720a, 720b, 750a and 750b is larger than the width W20 of the second projecting portions 720d and 750d, a firing voltage between a first electrode 730 and a second electrode 760 can be lowered. Further, since an area of the opposing electrodes increases, the intensity of a discharge can increase.

As illustrated in FIG. 17, a width W20 of the first projecting portions 720a, 720b, 750a and 750b may be smaller than a width W10 of the second projecting portions 720d and 750d.

When the width W10 of the second projecting portions 720d and 750d is larger than the width W20 of the first projecting portions 720a, 720b, 750a and 750b, a discharge generated inside a discharge cell can be efficiently diffused into the rear of the discharge cell.

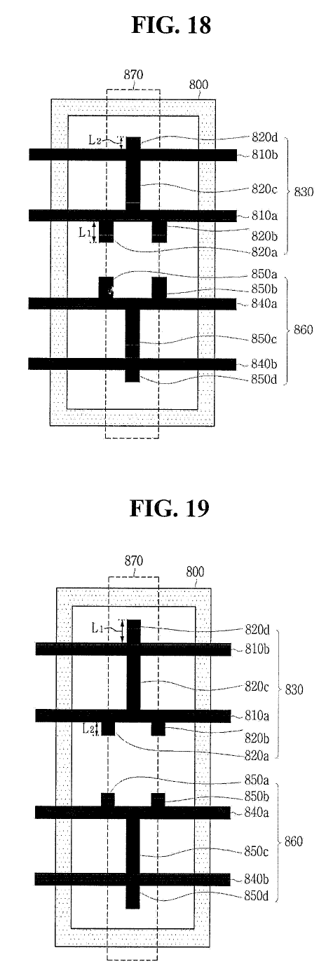

As illustrated in FIG. 18, a length of first projecting portions 820a, 820b, 850a and 850b may be different from a length of second projecting portions 820d and 850d. For instance, when a length L1 of the first projecting portions 820a, 820b, 850a and 850b is larger than a length L2 of the second projecting portions 820d and 850d, a firing voltage of a discharge generated between a first electrode 830 and a second electrode 860 can be lowered.

As illustrated in FIG. 19, a length L2 of the first projecting portions 820a, 820b, 850a and 850b may be smaller than a L1 length of the second projecting portions 820d and 850d. When the length L1 of the second projecting portions 820d and 850d is longer than the length L2 of the first projecting portions 820a, 820b, 850a and 850b, a discharge can be efficiently diffused into the rear of the discharge cell.

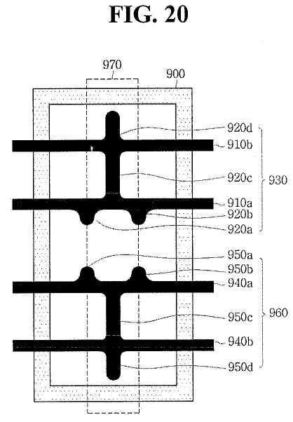

As illustrated in FIG. 20, at least one of a plurality of projecting portions 920a, 920b, 920d, 950a, 950b and 950d may include a portion with the curvature. A portion where line portions 910a, 910b, 940a and 940b are connected to connecting portions 920c and 950c may include the curvature. When a first electrode 930 or a second electrode 960 include a portion with the curvature, the first electrode 930 and the second electrode 960 can be easily manufactured. Further, the portion with the curvature prevents wall charges from being excessively accumulated on a specific portion during a driving of the panel, and thus a driving stability can be improved.

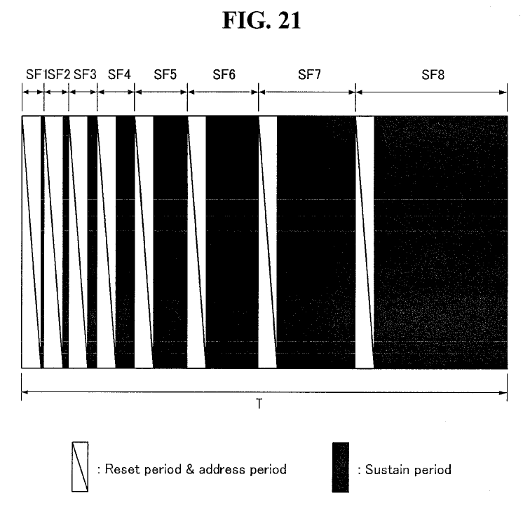

As illustrated in FIG. 21, a frame for achieving a gray scale of an image in the plasma display apparatus according to the exemplary embodiment is divided into several subfields each having a different number of emission times.

Each subfield is subdivided into a reset period for initializing all the cells, an address period for selecting cells to be discharged, and a sustain period for representing gray level in accordance with the number of discharges.

For instance, one frame, as illustrated in FIG. 21, is divided into 8 subfields SF1 to SF8. Each of the 8 subfields SF1 to SF8 is subdivided into a reset period, an address period, and a sustain period. Of course, at least one of a reset period, an address period and a sustain period may be omitted for the improvement of a driving margin or an increase in the representability of gray scale. The number of sustain signals supplied during the sustain period determines gray level weight in each of the subfields.

The plasma display apparatus according to the exemplary embodiment uses a plurality of frames to display an image for 1 second. For instance, 60 frames are used to display an image 1 second. In this case, a time width T of one frame may be 1/60 seconds, i.e., 16.67 ms.

In FIG. 21, the subfields are arranged in increasing order of gray level weight. However, the subfields may be arranged in decreasing order of gray level weight, or the subfields may be arranged regardless of gray level weight.

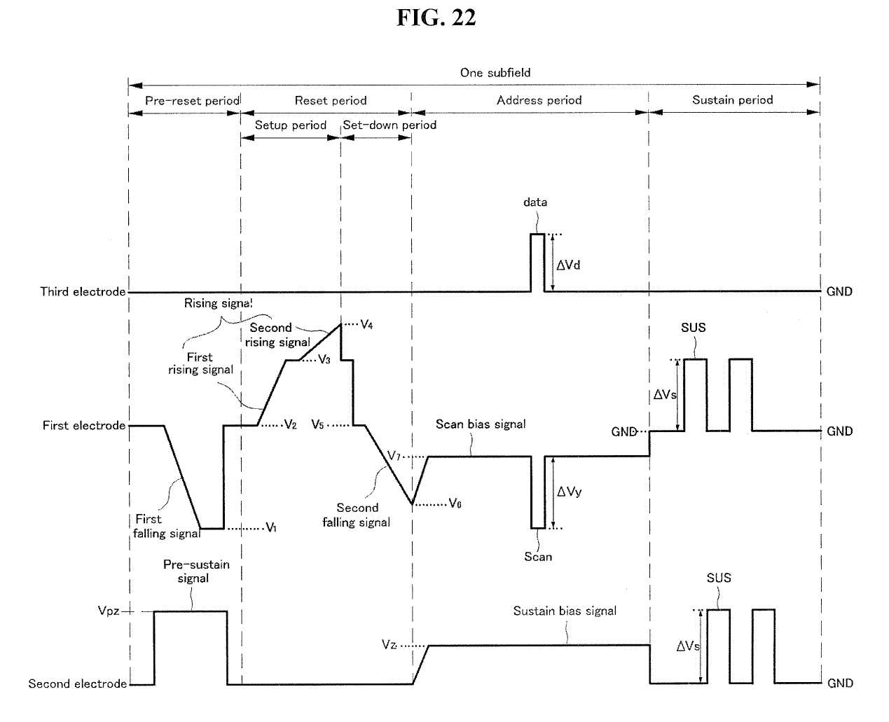

As illustrated in FIG. 22, during a pre-reset period prior to a reset period, a first falling signal with a gradually falling voltage is supplied to a first electrode. During the supply of the first falling signal to the first electrode, a pre-sustain signal of a polarity direction opposite a polarity direction of the first falling signal is supplied to a second electrode. The first falling signal supplied to the first electrode gradually falls to a first voltage V1.

The pre-sustain signal is substantially maintained at a pre-sustain voltage Vpz. The pre-sustain voltage Vpz is substantially equal to a voltage (i.e., a sustain voltage Vs) of a sustain signal (SUS) which will be supplied during a sustain period.

As above, during the pre-reset period, the first falling signal is supplied to the first electrode and the pre-sustain signal is supplied to the second electrode. Hence, wall charges of a predetermined polarity are accumulated on the first electrode, and wall charges of a polarity opposite the polarity of the wall charges accumulated on the first electrode are accumulated on the second electrode. As a result, the initialization of all the discharge cells can be performed stably so that a setup discharge with the sufficient intensity occurs during the reset period.

A subfield, which is first arranged in time order in a plurality of subfields of one frame, may include a pre-reset period prior to a reset period. Further, two or three subfields may include a pre-reset period prior to a reset period. All the subfields may not include the pre-reset period.

The reset period is further divided into a setup period and a set-down period. During the setup period, a rising signal of a polarity direction opposite a polarity direction of the first falling signal is supplied to the first electrode.

The rising signal includes a first rising signal and a second rising signal. The first rising signal gradually rises from a second voltage V2 to a third voltage V3 with a first slope, and the second rising signal gradually rises from the third voltage V3 to a fourth voltage V4 with a second slope.

The rising signal generates a weak dark discharge (i.e., a setup discharge) inside the discharge cell during the setup period, thereby accumulating a proper amount of wall charges inside the discharge cell.

The second slope of the second rising signal is gentler than the first slope of the first rising signal. When the second slope is gentler than the first slope, the quantity of light generated by the setup discharge is reduced. Accordingly, a contrast characteristic can be improved.

During the set-down period, a second falling signal of a polarity direction opposite a polarity direction of the rising signal is supplied to the first electrode. The second falling signal gradually falls from a fifth voltage V5 to a sixth voltage V6.

The second falling signal generates a weak erase discharge (i.e., a set-down discharge) inside the discharge cell. Further, the remaining wall charges are uniform inside the discharge cells to the extent that an address discharge can be stably performed.

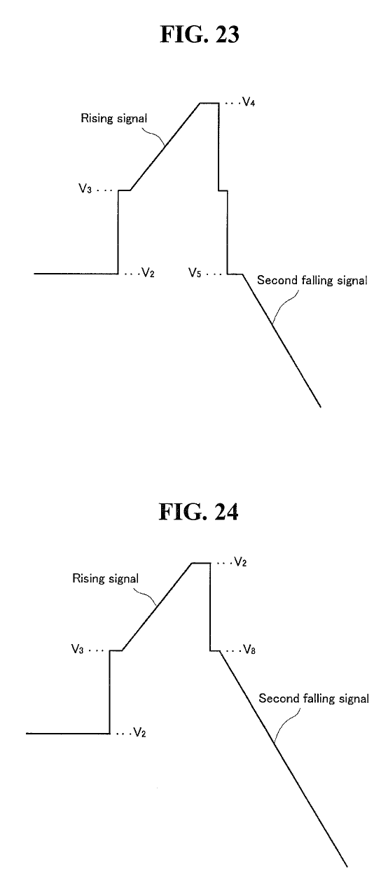

As illustrated in FIG. 23, the rising signal sharply may rise from the second voltage V2 to the third voltage V3, and then may gradually rise from the third voltage V3 to the fourth voltage V4.

As illustrated in FIG. 24, the second falling signal gradually falls from an eighth voltage V8. The eighth voltage V8 may be substantially equal to or different from the third voltage V3.

Referring again to FIG. 22, during an address period, a scan bias signal, which is maintained at a voltage higher than a lowest voltage (i.e., the sixth voltage V6) of the second falling signal, is supplied to the first electrode. A scan signal (Scan), which falls from the scan bias signal by a scan voltage magnitude ΔVy, is supplied to the first electrode.

A width of the scan signal may vary from one subfield to the next subfield. For instance, a width of a scan signal in a subfield may be larger than the width of a scan signal in the next subfield in time order.

As above, when the scan signal (Scan) is supplied to the first electrode, a data signal (data) corresponding to the scan signal (Scan) is supplied to the third electrode. The data signal (data) rises from a ground level voltage GND by a data voltage magnitude ΔVd.

As the voltage difference between the scan signal (Scan) and the data signal (data) is added to the wall voltage generated during the reset period, the address discharge occurs inside the discharge cell to which the data signal (data) is supplied.

A sustain bias signal is supplied to the second electrode during the address period so as to prevent the generation of the unstable address discharge caused by interference of the second electrode.

The sustain bias signal is substantially maintained at a sustain bias voltage Vz. The sustain bias voltage Vz is lower than the voltage Vs of the sustain signal and is higher than the ground level voltage GND.

During the sustain period, a sustain signal (SUS) is alternately supplied to the first electrode and the second electrode. As the wall voltage within the discharge cell selected by performing the address discharge is added to the sustain voltage Vs, every time the sustain signal (SUS) is supplied, a sustain discharge occurs between the first electrode and the second electrode. Accordingly, a predetermined image is displayed on the plasma display panel.

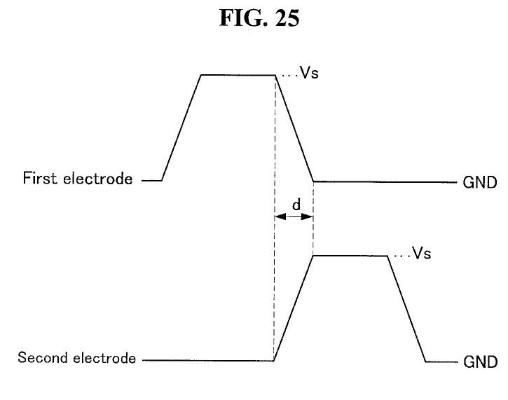

FIG. 25 illustrates a first implementation of a sustain signal. As illustrated in FIG. 25, a sustain signal supplied to the first electrode overlaps a sustain signal supplied to the second electrode during a period (d) of a sustain period of a frame.

As above, when the sustain signal supplied to the first electrode overlaps the sustain signal supplied to the second electrode, wall charges produced by the sustain signal supplied to the first electrode can contribute to a sustain discharge generated when the sustain signal is supplied to the second electrode. Hence, the driving efficiency can be improved.

A panel structure in which at least one of the first electrode or the second electrode has a single-layered structure has a higher firing voltage than a panel structure including a transparent electrode. Accordingly, it is advantageous that a sustain signal supplied to the first electrode overlaps a sustain signal supplied to the second electrode in consideration of the driving efficiency.

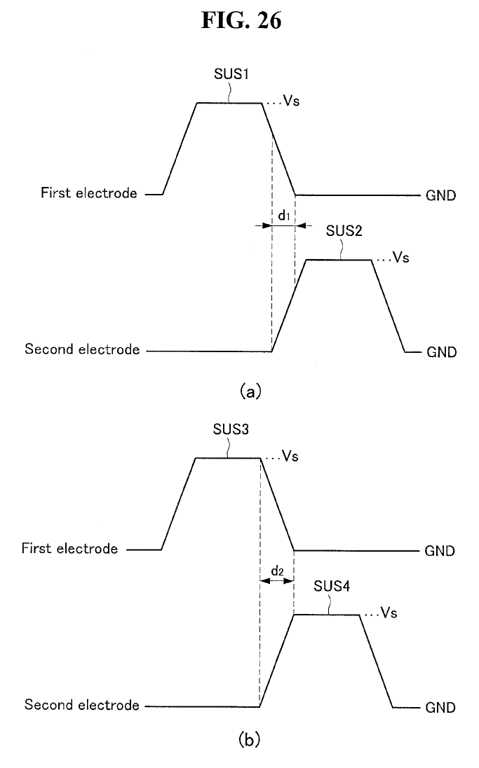

FIG. 26 illustrates a second implementation of a sustain signal. As illustrated in (a) of FIG. 26, when a first sustain signal SUS1 and a second sustain signal SUS2 are successively supplied to the first electrode and the second electrode, respectively, the first sustain signal SUS1 and the second sustain signal SUS2 may overlap each other during a period d1.

As illustrated in (b) of FIG. 26, when a third sustain signal SUS3 and a fourth sustain signal SUS4 are successively supplied to the first electrode and the second electrode, respectively, the third sustain signal SUS3 and the fourth sustain signal SUS4 may overlap each other during a period d2 whose a time width is longer than a time width of the period d1. As illustrated in FIG. 26, the generation of image sticking during the driving of the panel can be prevented by setting time widths of overlapping periods of the sustain signals to be different from each other.

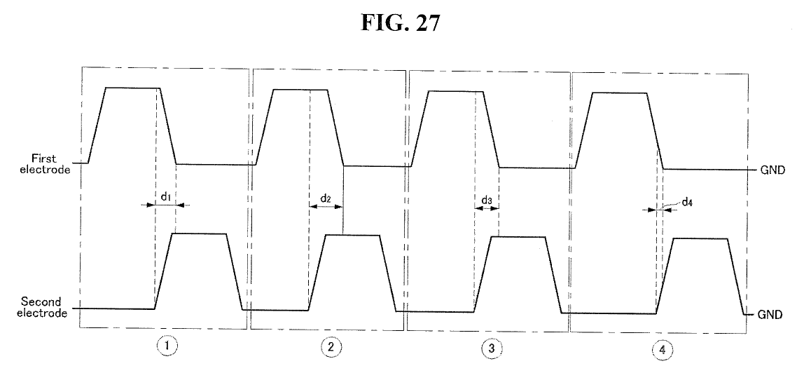

FIG. 27 illustrates a case of using three or more types of sustain signals. In each type \textcircled{1}, \textcircled{2}, \textcircled{3} and \textcircled{4}, sustain signals supplied to the first and second electrodes overlap each other during periods d1, d2, d3 and d4, respectively. Time widths of the periods d1, d2, d3 and d4 are different from one another.

The driving efficiency can be improved and the generation of image sticking can be further prevented by using three or more types of sustain signals.

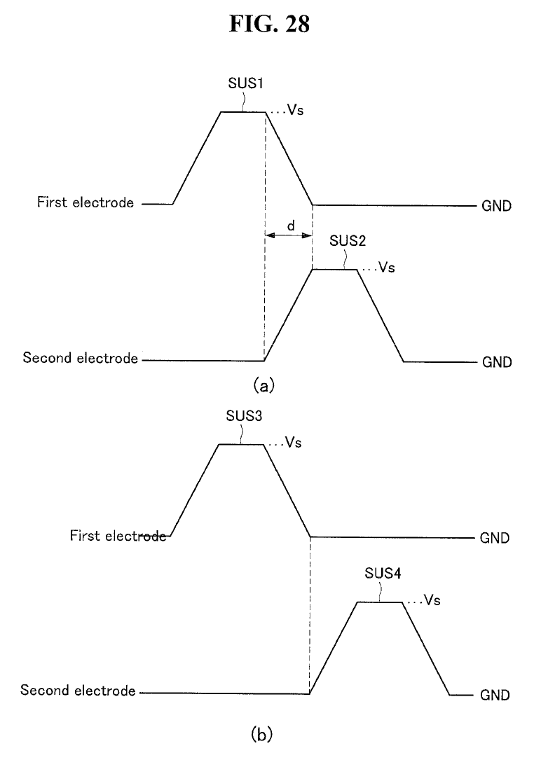

FIG. 28 illustrates a fourth implementation of a sustain signal.

While two sustain signals overlap each other during a period d in (a) of FIG. 28, two sustain signals do not overlap each other in (b) of FIG. 28.

As illustrated in FIG. 28, a type in which the sustain signals overlap each other and a type in which the sustain signals do not overlap may be used together.

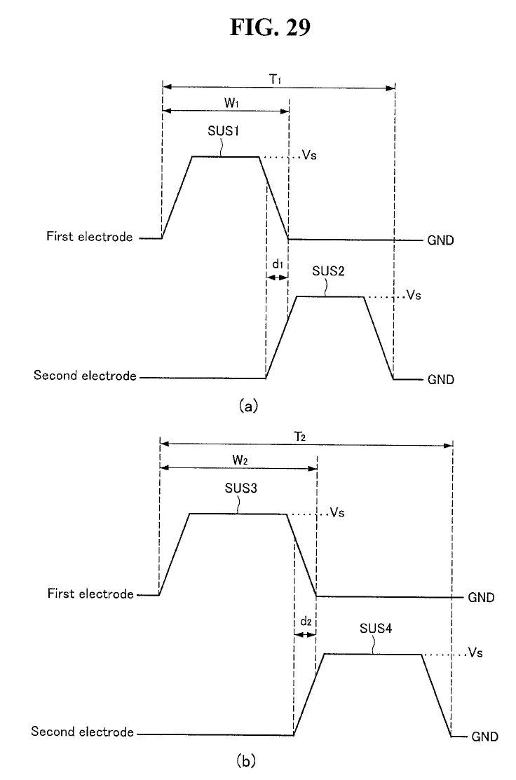

FIG. 29 illustrates a fifth implementation of a sustain signal.

In FIG. 29, d1 and d2 indicate an overlapping period of two sustain signals, W1 and W2 indicate the pulse widths of first and third sustain signals SUS1 and SUS3, respectively, and T1 and T2 indicate the duration (i.e., a period) of one complete cycle of each of the first and third sustain signals. The pulse widths W1 and W2 may be substantially equal to or different from each other. Further, the periods T1 and T2 may be substantially equal to or different from each other.

Time widths of the overlapping periods d1 and d2 may be substantially equal to or different from each other. The period T1 or T2 may range from 4 μs to 6 μs.

The generation of image sticking can be further prevented by overlapping the sustain signal supplied to the first electrode with the sustain signal supplied to the second electrode and adjusting the pulse width or the period of the sustain signal.

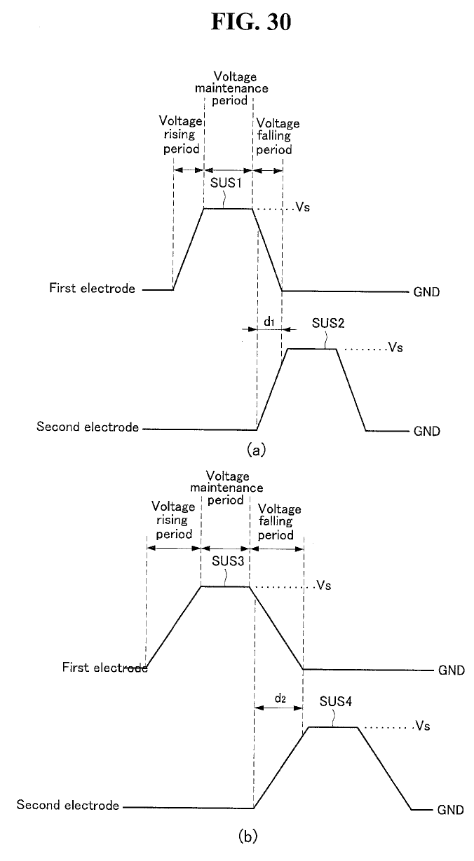

FIG. 30 illustrates a sixth implementation of a sustain signal.

As illustrated in (a) of FIG. 30, a first sustain signal SUS1 supplied to the first electrode overlaps a second sustain signal SUS2 supplied to the second electrode during a period d1. Each of the first sustain signal SUS1 and the second sustain signal SUS2 may include a voltage rising period, a voltage maintenance period and a voltage falling period.

As illustrated in (b) of FIG. 30, a third sustain signal SUS3 supplied to the first electrode overlaps a fourth sustain signal SUS4 supplied to the second electrode during a period d2. At least one of a voltage rising period, a voltage maintenance period and a voltage falling period of each of the third sustain signal SUS3 and the fourth sustain signal SUS4 may longer than at least one of the voltage rising period, the voltage maintenance period and the voltage falling period in (a) of FIG. 30.

A time width of the overlapping period d1 may be substantially equal to or different from a time width of the overlapping period d2. Further, the voltage rising period in (a) or (b) of FIG. 30 may range from 500 ns to 800 ns.

The generation of image sticking can be further prevented by overlapping the sustain signal supplied to the first electrode with the sustain signal supplied to the second electrode and adjusting at least one of the voltage rising period, the voltage maintenance period and the voltage falling period of the sustain signal.

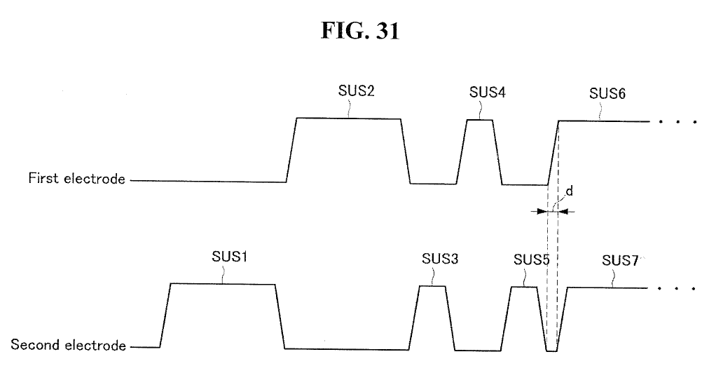

FIG. 31 illustrates a seventh implementation of a sustain signal.

A last sustain signal SUS6 supplied to the first electrode overlaps a last sustain signal SUS7 supplied to the second electrode during a period d of a predetermined subfield. In other words, an overlapping state of the last sustain signal SUS6 and the last sustain signal SUS7 is maintained until the predetermined subfield ends.

As a time width of the overlapping period d of the last sustain signals supplied to the first and second electrodes becomes longer during a sustain period of the predetermined subfield, the initialization of discharge cells can be easily performed during a reset period of a next subfield following the predetermined subfield using wall charges produced during the sustain period of the predetermined subfield. Hence, the driving efficiency can be improved.

The reliability of a first generated sustain discharge can be improved by setting pulse widths of a first sustain signal SUS1 and a second sustain signal SUS2 to be longer than a pulse width of the other sustain signals.

As above, the plasma display panel according to the exemplary embodiment can be manufactured using a simple manufacturing process at the low manufacturing cost by forming at least one of the first electrode or the second electrode in a single-layered structure.

Further, the driving efficiency can be improved and the generation of image sticking can be prevented by overlapping the sustain signal supplied to the first electrode with the sustain signal supplied to the second electrode.

Embodiments of the invention being thus described, it will be obvious that the same may be varied in many ways. Such variations are not to be regarded as a departure from the scope of the invention, and all such modifications as would be obvious to one skilled in the art are intended to be included within the scope of the following claims.

What is claimed is:

1. A plasma display apparatus comprising:
a plasma display panel including a first electrode, a second electrode and a third electrode intersecting the first electrode and the second electrode, at least one of the first electrode and the second electrode having a singe-layered structure; and
a driver that supplies sustain signals to the first electrode and the second electrode during a sustain period of a frame,
wherein the sustain signal supplied to the first electrode overlaps the sustain signal supplied to the second electrode.

2. The plasma display apparatus of claim 1, wherein at least one of the first electrode and the second electrode is a bus electrode.

3. The plasma display apparatus of claim 1, wherein a black layer is positioned between at least one of the first electrode and the second electrode and a front substrate and has a color darker than a color of at least one of the first electrode and the second electrode.

4. The plasma display apparatus of claim 1, wherein at least one of the first electrode and the second electrode includes at least one line portion intersecting the third electrode and at least one projecting portion projecting from the line portion.

5. The plasma display apparatus of claim 4, wherein the projecting portion includes a portion with the curvature.

6. The plasma display apparatus of claim 4, wherein at least one projecting portion includes at least one first projecting portion projecting toward the center of a discharge cell and at least one second projecting portion projecting in an outward direction of the discharge cell.

7. The plasma display apparatus of claim 6, wherein a length or width of the first projecting portion is different from a length or width of the second projecting portion.

8. The plasma display apparatus of claim 4, wherein the projecting portion overlaps the third electrode.

9. The plasma display apparatus of claim 4, wherein the number of line portions is plural, and
at least one of the first electrode and the second electrode includes at least one connecting portion connecting the plurality of line portions to each other.

10. The plasma display apparatus of claim 1, wherein the driver successively supplies first and second sustain signals to the first and second electrodes, respectively,
the driver successively supplies third and fourth sustain signals to the first and second electrodes, respectively,
the first sustain signal overlaps the second sustain signal during a first period, and
the third sustain signal overlaps the fourth sustain signal during a second period whose a time width is different from a time width of the first period.

11. The plasma display apparatus of claim 1, wherein the driver supplies a last sustain signal to each of the first and second electrodes during a sustain period of a predetermined subfield, and
the last sustain signal supplied to the first electrode overlaps the last sustain signal supplied to the second electrode until the predetermined subfield ends.

12. A method of driving a plasma display apparatus including a plasma display panel including a first electrode, a second electrode and a third electrode intersecting the first electrode and the second electrode, at least one of the first electrode and the second electrode having a singe-layered structure, the method comprising:
supplying first and second sustain signals to the first electrode and the second electrode, respectively, so that the first sustain signal supplied to the first electrode overlaps the second sustain signal supplied to the second electrode.

13. The method of claim 12, wherein a voltage rising period of the first sustain signal overlaps a voltage falling period of the second sustain signal, or a voltage falling period of the first sustain signal overlaps a voltage rising period of the second sustain signal.

14. The method of claim 12, wherein a voltage rising period of the first sustain signal overlaps a voltage falling period of the second sustain signal, and a voltage falling period of the first sustain signal overlaps a voltage rising period of the second sustain signal.

15. The method of claim 12, wherein a time width of at least one of a voltage rising period, a voltage maintenance period and a voltage falling period of the first sustain signal is different from a time width of at least one of a voltage rising period, a voltage maintenance period and a voltage falling period of the second sustain signal.

16. A method of driving a plasma display apparatus including a plasma display panel including a first electrode, a second electrode and a third electrode intersecting the first electrode and the second electrode, at least one of the first electrode and the second electrode having a singe-layered structure, the method comprising:
successively supplying first and second sustain signals to the first and second electrodes, respectively; and
successively supplying third and fourth sustain signals to the first and second electrodes, respectively,
wherein the first sustain signal overlaps the second sustain signal during a first period, and
the third sustain signal overlaps the fourth sustain signal during a second period whose a time width is different from a time width of the first period.

17. The method of claim 16, wherein a period of a sustain signal including the first sustain signal and the second sustain signal is different from a period of a sustain signal including the third sustain signal and the fourth sustain signal.
